(19) United States
(12) Patent Application Publication
(10) Pub. No.: US 2020/0086219 A1
(43) Pub. Date: Mar. 19, 2020

(54) AUGMENTED REALITY-BASED SPORTS GAME SIMULATION SYSTEM AND METHOD THEREOF

(71) Applicant: LOTUSECO CO LTD, Seoul (KR)

(72) Inventors: Jae Ryong SHIM, Ansan-si (KR); Ho Seok KANG, Seoul (KR)

(21) Appl. No.: 16/480,866

(22) PCT Filed: Jan. 26, 2018
(86) PCT No.: PCT/KR2018/001199

§ 371 Date: Nov. 13, 2019

(30) Foreign Application Priority Data
Jan. 26, 2017 (KR) 10-2017-0013004

(51) Int. Cl. A63F 13/816; G06T 19/00; G02B 27/01

(52) U.S. Cl. CPC A63F 13/816; G02B 27/017; G06T 19/006

(57) ABSTRACT

A sports game simulation method through wearable glasses which support an augmented reality mode according to the present invention includes the steps of: receiving information on a size of an actual physical space; generating an entire game space based on the information on the size of the actual physical space; displaying a virtual object to be overlaid on the entire game space; receiving information on a user's movement; and updating position information of the virtual object in the entire game space based on the information on the motion of the user.

### TECHNICAL FIELD

The present invention relates to a system and a method for playing sports game based on an augmented reality (AR) technology.

### BACKGROUND ART

A virtual reality (VR) based sports game simulation gives a high degree of immersion by providing multi-point images from viewpoints of players who participate in an actual game. However, the user's field of view is completely blocked due to the nature of the VR, so that physical movement of the user is limited. Even though the user virtually participates in the sports game, an amount of physically required motion to the user is extremely small and there are many limitations in the physical movement.

If the game is produced based on augmented reality (AR), a virtual object is represented to be overlaid on an actual physical space so that the user may perform motions such as walking, running, or jumping on an actual physical space, which results in a similar effect to the actual exercise.

### DISCLOSURE

### Technical Problem

An object of the present invention is to provide a physical experience similar to a physical experience obtained by participating in an actual sports game to a user who participates in a virtual sports game. Further, an object of the present invention is to provide an exercise experience which is adaptively optimized to a user who participates in the virtual sports even in a limited physical space.

### Technical Solution

A sports game simulation system through an augmented reality according to the present invention includes: wearable glasses which includes a display to display a virtual object to be overlaid with an actual physical space and a battery to supply a power and is wearable around a head of a user; a camera sensor which scans a physical space where the sports game is played; and a real object used for the sports game.

The wearable glasses display a virtual object based on information on a game progress on the physical space received from the camera sensor. The real object is at least one of a ball, a stone, a racket, a bat, a stick, a broom, and gloves. The real object includes an inertial measurement unit (IMU) sensor.

The wearable glasses generate an entire game space so as to limit a space where a physical movement of the user is expected, of the entire game space where the sports are playing, within the actual physical space. The wearable glasses manage the entire game space so as to discontinuously change a space where a physical movement of the user is expected, of the entire game space where the sports are playing. According to the exemplary embodiment of the present invention, a calculation required to dynamically manage the entire game space is performed by the wearable glasses. However, in order to reduce the burden of the wearable glasses, depending on the implementation, the calculation may be processed by a separate computing device (for example, a server).

A sports game simulation method through wearable glasses which support an augmented reality mode according to the present invention includes: receiving information on an actual physical space; generating an entire game space based on the information on the actual physical space; displaying a virtual object to be overlaid on the entire game space; receiving information on a motion of a user; receiving information on a motion of a real object; and updating position information of the virtual object in the entire game space based on the information on the motion of the user and motion of a real object.

The entire game space is generated to be equal to or larger than the actual physical space. The entire game space is generated to be configured by an actual physical space and a pure virtual space. The entire game space is generated to be included in the actual physical space by an external input.

The entire game space is generated to be configured by a space expected that a physical movement of the user is generated and a space expected that the physical movement of the user is not generated. In the generating of an entire game space, the game space is adaptively configured by at least one of a role of the user in the game, a body condition of the user, and a choice of the user.

### Advantageous Effects

According to the present invention, an augmented reality based sports game simulation system and a method thereof may provide an experience similar to an experience obtained by participating in an actual sports game to a user.

### DESCRIPTION OF DRAWINGS

FIG. 1 is a view illustrating an exemplary embodiment of a system for performing augmented reality based sports game simulation according to the present invention.

FIG. 2 is a view illustrating a scenario in which Curling which is one of winter sports events is played using an augmented reality based sports game simulation system according to the present invention.

FIG. 3 is a view illustrating some exemplary embodiments of a configuration of a game space used in an augmented reality based sports game simulation system according to the present invention.

FIG. 4 is a view illustrating an example in which a game space illustrated in FIG. 3B is applied to a Curling game.

FIG. 5 is a flowchart illustrating a game space setting procedure according to an exemplary embodiment of the present invention.

FIG. 6 is a flowchart illustrating a procedure performed when a physical space is changed in an augmented reality based sports game simulation system according to the present invention.

FIG. 7 is a flowchart illustrating a procedure which processes a request from a user to play a game in an augmented reality based sports game simulation system according to the present invention.

FIG. 8 is a flowchart illustrating a procedure of switching scenes during game simulation according to an exemplary embodiment of the present invention.

FIG. 9 is a flowchart illustrating a game space setting procedure according to an exemplary embodiment of the present invention.

FIGS. 10A and 10B are views illustrating an exemplary embodiment of a system for performing augmented reality based sports game simulation according to the present invention.

### BEST MODE

Hereinafter, the present invention will be described more fully hereinafter with reference to the accompanying drawings, in which exemplary embodiments of the invention are shown. However, it is obvious to those skilled in the art that the scope of the present invention is not limited only the exemplary embodiments to be described herein but various modifications may be allowed while maintaining substantially equivalent to the present invention.

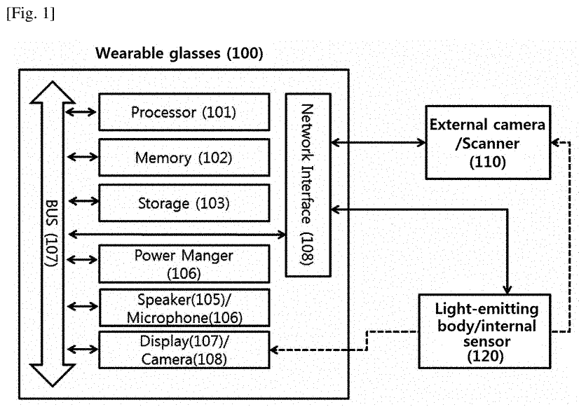

FIG. 1 is a view illustrating an exemplary embodiment of a system for performing augmented reality based sports game simulation according to the present invention. A system may include wearable glasses 100, an external camera and/or scanner 110, a light emitting body and/or inertial sensor 120. The wearable glasses according to the present invention may be any type of smart glasses including Hololens by Microsoft which may be worn on the user's head and supports augmented reality functions. As illustrated in FIG. 1, the wearable glasses include a processor 101 which performs all operations required to play a game in an augmented reality mode, a memory 102 which temporarily stores data, a storage 103 which stores various data, a power manager 106 which controls power consumption of the wearable glasses, a speaker 105 which outputs audio, a microphone 106 which inputs audio, a display 107 which displays an augmented reality mode, and a camera 108 which obtains an image from a physical space. Another kind of scanner may be further included instead of the camera 108 or additionally to the camera 108. The external camera or the external scanner 110 is provided to obtain information on a space where the game is played, a person, or a real object and may be omitted depending on the implementation. However, for more precise game simulation, one or more external cameras or external scanners may be installed. The light-emitting body or inertial sensor 120 may be manufactured to be detachable from a tool (for example, a ball, a stone, a racket, a bat, a stick, a broom, or gloves) used in the corresponding sports event or integrally manufactured with the tool.

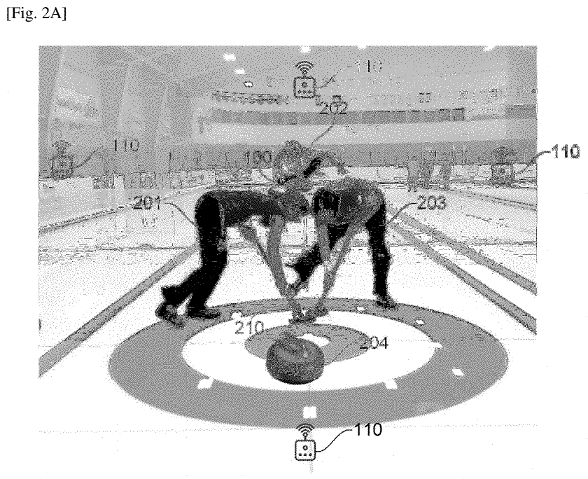

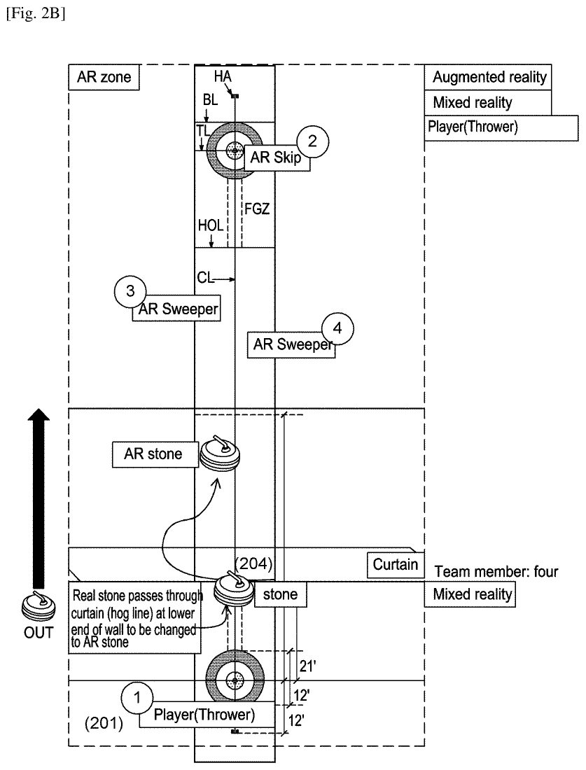

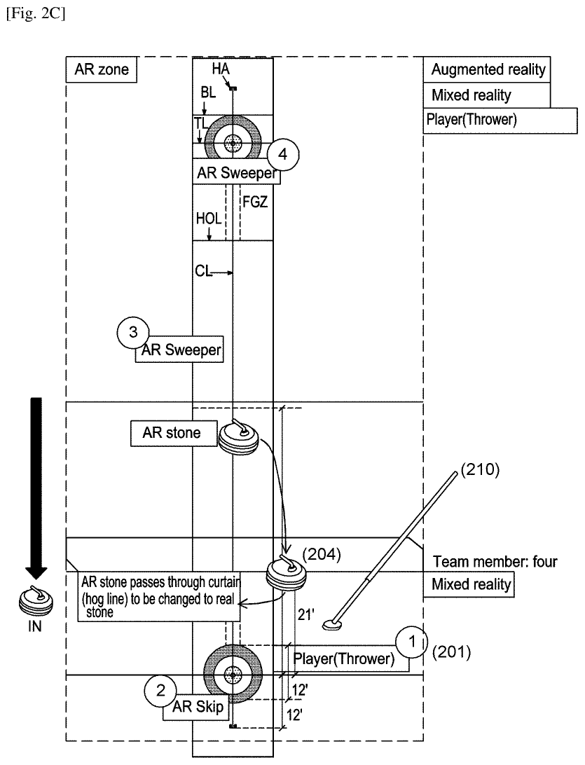

FIG. 2A illustrates a scene of a Curling game utilizing the above-described simulation system. A user 201 plays a role of a sweeper and a Thrower 202, a fellow Sweeper 203, and a stone 204 are all virtual objects. A broom 210 held by the user 201 in his/her hand is a real object and a light emitting body and/or the inertial sensor 120 is attached thereto or installed therein. Here, the light emitting body provides information on an accurate position of the broom to a plurality of external cameras 110 and the camera 108 installed in the wearable glasses 100 and the inertial sensor 120 is a general inertial measurement unit (IMU) sensor and provides detailed information on a motion of the broom. Depending on the application, only any one of the light emitting body and the IMU sensor may be used or both the light emitting body and the IMU sensor may be used. The external camera 110 obtains not only the position of the broom, but also image information on the user to transmit the information to the wearable glasses.

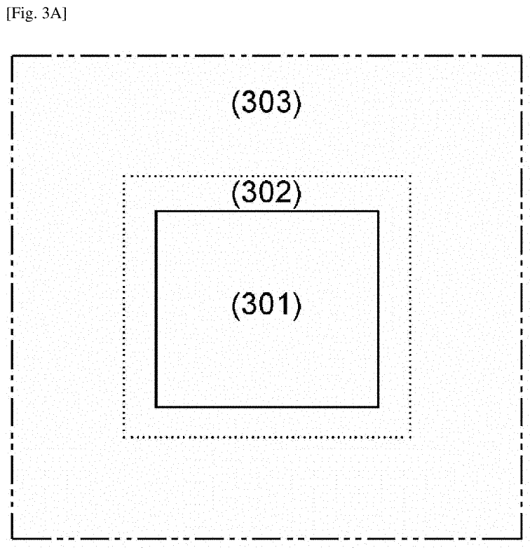

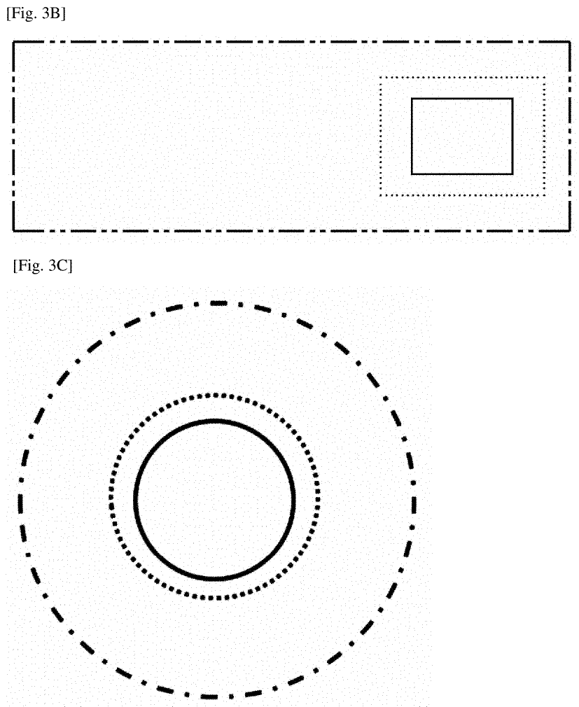

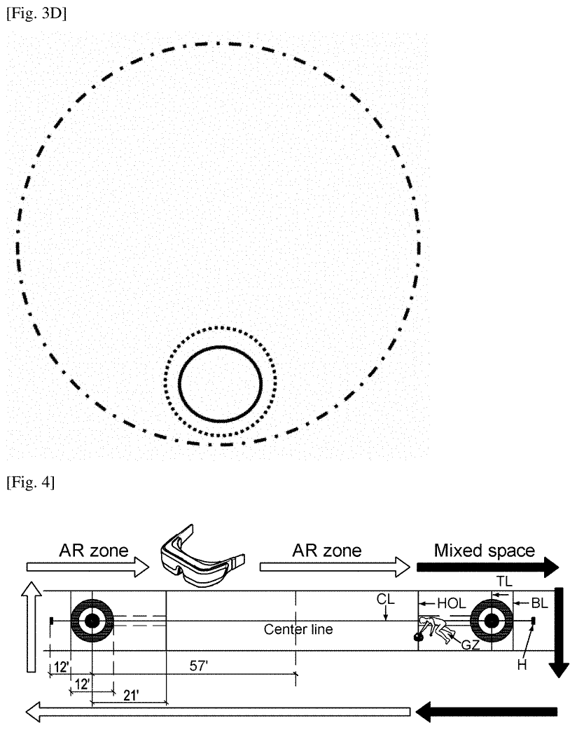

A game space according to the present invention will be described briefly. In FIGS. 3A to 3D, an area 301 represented by a solid line is an area expected that a motion of the user will be generated and an area 302 represented by a dotted line is a safe area including an additional area which is secured for safety of the user and both areas are actually present in the physical space. Further, an area 303 represented by a two-dot chain line represents an entire game space. In the area 301, all the user, a real object, and a virtual object may be located. A space which is additionally secured in the area 302 from the area 301 is a buffer area for the safety of the user and is intended such that the user or the real object is not located during the game. Further, an area of the area 303 excluding the area 302 (and area 301) is a space in which only the virtual object is represented. As illustrated in FIGS. 3A to 3D, the area 301 is included in the area 302 and the area 302 is included in the area 303. The configuration of the game space as described above corresponds to a geometric space considered to be rendered in the wearable glasses and the entire space is managed by a three-dimensional coordinate system to play a game. As described above, a geometric three-dimensional game space considered for rendering only partially matches an actual physical space (that is, the area 301) and includes a virtual space which does not exist actually. However, in some implementation, the geometric three-dimensional game space considered for rendering may completely match the actual physical space.

### Virtualization of Actual Stone

FIG. 2B illustrates a scene of a Curling game utilizing the above-described simulation system. The user 201 plays a role of a thrower 202 and a stone 204 is an object which exists in the form of a real object in the areas 301 and 302. All the sweeper 203, the broom, and the skip existing in the area 303 are virtual objects. The stone 204 held by the user 201 in his/her hand is a real object and the light emitting body and/or inertial sensor 120 is attached thereto or installed therein. Here, the light emitting body provides information on an accurate position of the stone to a plurality of external cameras 110 and the camera 108 installed in the wearable glasses 100 and the inertial sensor 120 is a general inertial measurement unit (IMU) sensor and provides detailed information on a motion of the stone. Depending on the application, any one of the light emitting body and the IMU sensor may be used or both the light emitting body and the IMU sensor may be used.

The external camera 110 obtains not only the position of the stone but also image information on the user to transmit the information to the wearable glasses. The stone which is applied with force by the user to be pushed enters the area 302 and disappears by a diminished reality technique and simultaneously a stone which is a virtual object appears in the area 303. In the areas 301, 302, and 303, virtual objects which exist from the beginning of the game are displayed and a stone which is virtualized as soon as the stone passes through the boundary zone to enter the area 302 interworks with another virtual objects to be displayed on the wearable glasses.

In order to seamlessly represent the operation of replacing the real stone with the virtual stone, the virtual stone may be rendered in advance to be accurately overlaid on the actual stone also in a zone where the real stone effectively exist.

### Actualization of Virtual Stone

FIG. 2C illustrates another scene of a Curling game utilizing the above-described simulation system. The user 201 plays a role of a sweeper and the broom 210 is an object which exists in the form of a real object in the areas 301 and 302. All the thrower 202, another sweeper 203, and the skip existing in the areas 301 and 202 are virtual objects. The stone 202 which is pushed by the thrower 202 enters a boundary point of a virtual space (an area of the area 303 which does not belong to the area 302) and the buffer area 302 and a control device (not illustrated) throws a real stone in accordance with a virtual traveling direction and a rotation speed to push the stone to the areas 301 and 302. The control device may be configured in a similar manner to a mechanical device which throws a ball in an indoor baseball park. In the areas 301, 302, and 303, virtual objects which exist from the beginning of the game are displayed and a stone which is actualized as soon as the virtual stone passes through the boundary zone to enter the area 302 interworks with another virtual objects to be displayed on the wearable glasses. The stone 204 is a real object and includes a light emitting body and/or an inertial sensor 120 attached thereto or installed therein. Here, the light emitting body provides information on an accurate position of the stone to a plurality of external cameras 110 and the camera 108 installed in the wearable glasses 100 and the inertial sensor 120 is a general inertial measurement unit (IMU) sensor and provides detailed information on a motion of the stone. Depending on the application, any one of the light emitting body and the IMU sensor may be used or both the light emitting body and the IMU sensor may be used.

An example in which the virtual stone is actualized has been described above, but not all the game modes in which the user 201 plays a role of a sweeper necessarily includes a step of actualizing a virtual stone. Therefore, the game may be played by representing the stone only as a virtual object state.

The broom 210 held by the user 201 in his/her hand is a real object and a light emitting body and/or an inertial sensor 120-1 is attached thereto or installed therein. Here, the light emitting body provides information on an accurate position of the broom to a plurality of external cameras 110 and the camera 108 installed in the wearable glasses 100 and the inertial sensor 120-1 which is attached to the broom is a general inertial measurement unit (IMU) sensor and provides detailed information on a motion of the broom. Depending on the application, any one of the light emitting body and the IMU sensor may be used or both the light emitting body and the IMU sensor may be used. The external camera 110 obtains not only the position of the stone and the broom but also image information on the user to transmit the information to the wearable glasses.

FIG. 3 is an exemplary diagram for explaining a game space for performing sports game simulation according to the present invention. For example, when a game is played in an indoor space, an area 301 is an indoor space in which a motion of the user is permitted and an area of an area 302 excluding the area 301 is an area serving as a buffer secured for the safety of the user. In contrast, an area of the area 303 excluding the area 302 may be a physical space or may not be. For example, there may be a wall at the end of the area 302. In this case, even though the actual physical space is blocked by the wall, the user may feel that a space in the area 303 (excluding the area 302) exists continuously with the area 302 by the help of the augmented reality. In this case, the immersion of the entire game space may be increased by using the appropriate perspective distortion effect while restricting the expected movement area of the user within a space where the safety is physically secured to be optimized.

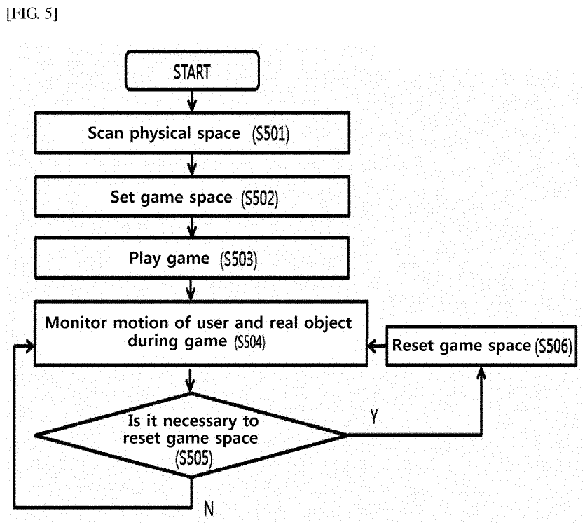

As described above, the entire game space 303 may be configured to include an area where the movement of the user is permitted and a buffer area 302 for securing the safety. However, as a result of checking through physical space scanning S501 as described in FIG. 5, when there is no risky element in the physical space and the actual physical space is larger than the entire game space, the buffer area 302 may not be necessary.

In FIG. 3A, even though the user's motion permission area 301, the buffer area 302, and the entire game area 303 are represented in a two-dimensional plane, it should be noted that each area may be generally considered in a three-dimension. In order to consider the three-dimension, any one or more of a rectangular coordinate system, a cylindrical coordinate system, and a spherical coordinate system may be selected. However, in the case of the outside, each area may be set in consideration of only two-dimension in accordance with a scanning result of a physical space. For example, in a wide space which is open without having obstacles, even though the game space is managed only in the two-dimension without considering a height dimension, the game may be smoothly played and unnecessary calculation may be reduced.

According to an exemplary embodiment, in a rendering step, the area 301, the area 302 (excluding an area overlaid with the area 301, the area 303 (excluding an area overlaid with the area 302) may be expressed to be visually distinguished. For example, at the time of rending, the rendering may be performed by varying color, brightness, saturation, resolution, and texture for various objects and backgrounds expressed in each area. As described above, the rendering is performed to visually distinguish the areas so that a probability that the user is exposed to a safety accident while playing the game may be significantly lowered.

The game space as illustrated in FIG. 3B may be appropriate when the user plays a role of a thrower in the curling game as illustrated in FIG. 4. Further, a game space as illustrated in FIG. 3D may be appropriate when the user plays a role of a hitter at a bat in the baseball game. Various game spaces may be configured in accordance with the feature of the game and the role of the user.

In order to configure the game space, a body size of the user may be desirably considered. A body size of the user may refer to a value such as a height, an arm length, a leg length, and a trunk circumference. An algorithm which receives a height or a height and a weight of the user and estimates a body size of the user from the information may be equipped. Alternatively, the body size of the user may be scanned using an external camera.

In addition to the body size of the user, the area 301 where the motion of the user is expected may be calculated in consideration of a size of a real object used for the game, such as a baseball bat, a stick, or a broom.

Further, in order to configure the game space, an area 301 where the motion of the user is expected may be estimated based on statistical data for an area where a player moves in an actual game.

FIG. 9 is a flowchart illustrating a game space setting procedure according to an exemplary embodiment of the present invention. Steps of scanning a physical space and determining a body size are performed in steps S901 and S902, but the steps are not necessarily sequentially performed in this order, but may be simultaneously performed. Next, a statistic prediction model is performed, which may be performed using statistical data for a motion of actual sports players and/or a probability prediction modeling technique which utilizes statistical data obtained from normal person. When the learning is performed using artificial intelligence, a statistical model which initially exists may become more elaborated by learning data collected from the user during the game. The area 301 where the user's motion is expected may be determined by performing the step S903 and a buffer area and the entire game space may be determined in step S906.

The physical space may be scanned by various methods. The physical space may be scanned solely by a camera or a scanner installed in the wearable glasses. As another method, a result obtained by an external camera or external scanner may be transmitted to the wearable glasses and information obtained from the camera and/or the scanner of the wearable glasses and the external camera/scanner is combined to scan the physical space.

In the sports game simulation system according to the present invention, the user may adjust the strength of the simulation. For example, when the user plays a role of a thrower in the Curling, a weight of the stone which is a real object may vary. The overall simulation may be adaptively changed in accordance with the weight of the stone. As another example, in the case of a track game which may be implemented only by the wearable glasses including the IMU sensor, players (AR objects) who run together in the nearby track while the user is running may show the same motion as real players such as Usain Bolt or may be virtual players with an ability in accordance with the level of the user. In this case, the motion of the AR object players may be programmed to have various levels using statistical data obtained from actual player.

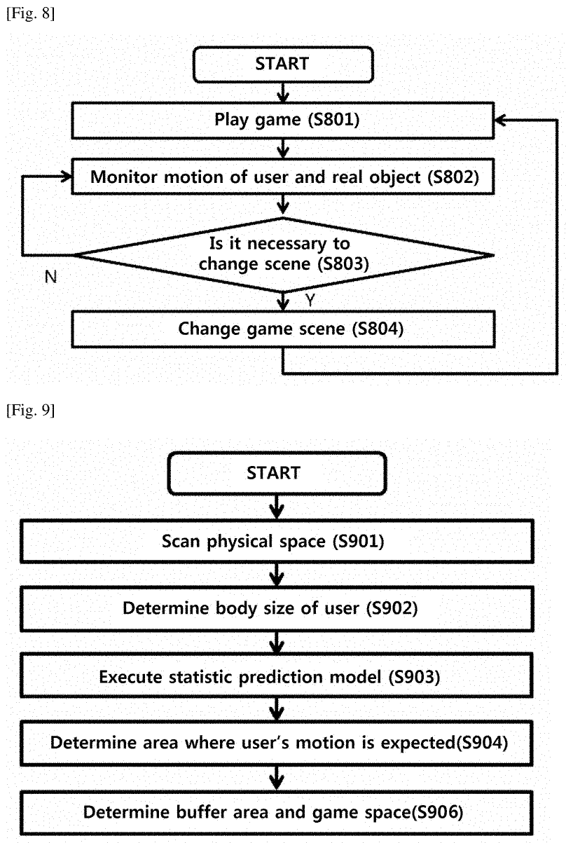

The game simulation system according to the present invention may be applied to various types of sports at the indoor and the outdoor. In the marathon, an AR object player which plays a role of a pace maker may be provided and various events such as tennis, baseball, soccer, and golf may be played. Specifically, in the soccer game, a role of the user may be extended to one or more player. For example, a role of the user is changed immediately after taking a corner kick, so as to receive a soccer ball and connect the ball to shooting. In this case, the scene needs to be switched so that the procedure as illustrated in FIG. 8 may be performed.

FIG. 5 illustrates a procedure of changing a previously set game space in accordance with a motion of the user. A game space is set after scanning a physical space and a motion of the user is monitored while playing the game, which is performed to check whether the motion of the user is limited in an expected area 301. If the motion of the user is out of a specific area or concentrated in a specific direction, it is determined whether it is necessary to reset a game space (that is, the areas 301, 302, and 303). If it is necessary to reset the game space, the resetting S506 is performed. In addition to steps illustrated in FIG. 5, when the user's safety becomes a problem, a step of warning to the user may be further provided.

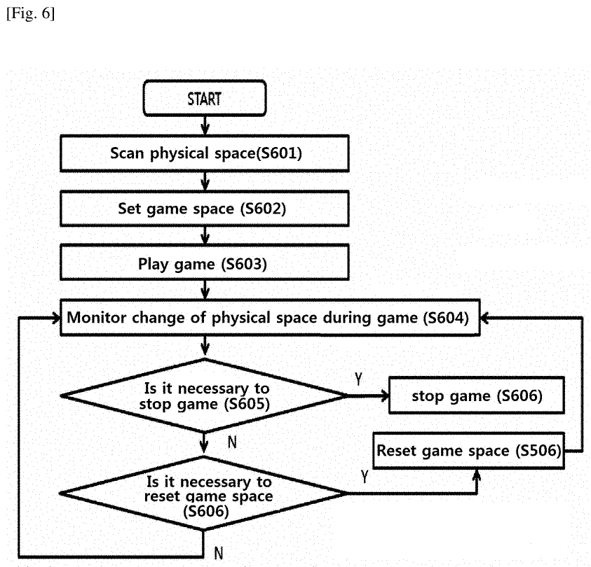

FIG. 6 illustrates a procedure of stopping the game or resetting a game space when a change is caused in the physical space during the game, for example, a third party or an obstacle enters the game space. In addition to steps illustrated in FIG. 6, a step of warning to the user may be further provided.

When the procedures illustrated in FIGS. 5 and 6 are performed, the warning to the user may be implemented by outputting a predetermined audio signal, a predetermined visual signal, or a mechanical signal such as vibration, or various combinations thereof.

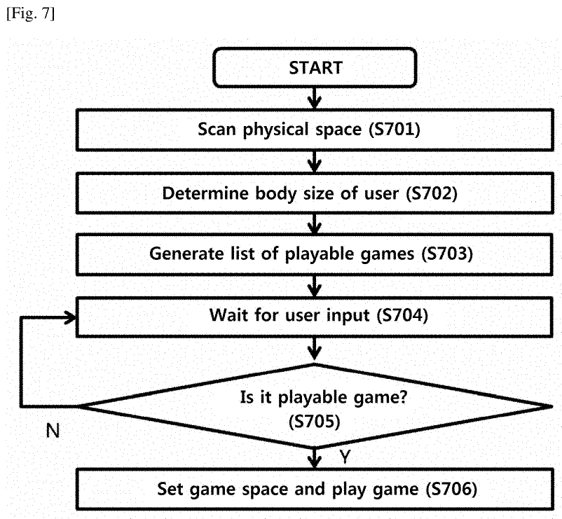

FIG. 7 illustrates a procedure of selecting a sports game event which can be performed by the user in the current physical space based on information on the physical space and information on a user's body size to suggest the sports game event to the user. It is advantageous that the procedure as illustrated in FIG. 7 is performed so that the user may check sports events which can be performed by the user in the current physical space at a glance.

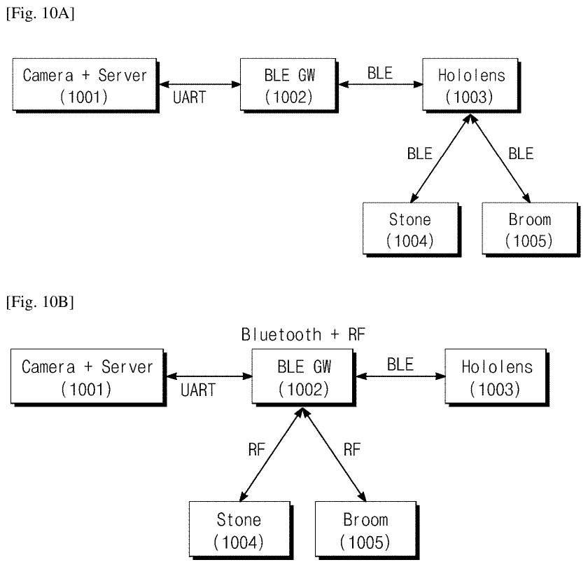

FIG. 10A illustrates an exemplary embodiment of a system for performing augmented reality based sports game simulation according to the present invention. A camera and a server are connected to a gateway 1002 by an UART method and the gateway 1002, a stone 1004, and a broom are connected to the Hololens 1003 by the Bluetooth (BLE) to perform the associated operation. That is, the Hololens 1003 receives information on motion obtained from IMU sensors installed in the stone 1004 and the broom 105 through a Bluetooth channel and receives the position information of the stone 1004 and the broom 1005 obtained from the camera through the UART channel via the camera and the server.

The configuration may be implemented in a partially modified manner as illustrated in FIG. 10B. Here, in order to minimize the delay which may be caused during the rendering process, the gateway 1002 independently uses UART, Bluetooth, and RF channel to communicate with the camera/server 1001, the Hololens 1003, the stone 1004/broom 1005. Here, the RF channel is a wireless communication channel dedicated for the game and RF424, 433, and 868 MHz which are ISM bands may be used, but is not limited thereto.

Further, in the configuration as illustrated in FIGS. 10A and 10B, the UART may be replaced with a general wired/wireless communication or inter-board communication method such as I2C or SPI or implemented by other various communication methods. In FIGS. 10A and 10B, the communication methods between the Hololens 1003, the stone 1004, the broom 1005, and the gateway 1002 are not limited to the Bluetooth and various wireless communication methods such as WiFi may be applied.

Even though all components of the exemplary embodiment may be combined as one component or operates to be combined, the present invention is not limited to the exemplary embodiment. In other words, one or more components may be selectively combined to be operated within a scope of the present invention. Further, all components may be implemented as one independent hardware but a part or all of the components are selectively combined to be implemented as a computer program which includes a program module which performs a part or all functions combined in one or plural hardwares. Further, such a computer program may be stored in a computer readable media such as a USB memory, a CD disk, or a flash memory to be read and executed by a computer to implement the exemplary embodiment of the present invention. The recording media of the computer program may include a magnetic recording medium or an optical recording medium.

The above description illustrates a technical spirit of the present invention as an example and various changes, modifications, and substitutions become apparent to those skilled in the art within a scope without departing from an essential characteristic of the present invention. Therefore, as is evident from the foregoing description, the exemplary embodiments and accompanying drawings disclosed in the present invention do not limit the technical spirit of the present invention and the scope of the technical spirit of the present invention is not limited by the exemplary embodiments and accompanying drawings. The protection scope of the present invention should be interpreted based on the following appended claims and it should be appreciated that all technical spirits included within a range equivalent thereto are included in the scope of the present invention.

1. A sports game simulation system based on augmented reality, comprising:
wearable glasses which include a display to display a virtual object to be overlaid with an actual physical space and a battery to supply a power and is wearable around a head of a user;
a camera sensor which scans a physical space where the sports game is played; and
a real object used for the sports game.

2. The sports game simulation system of claim 1, wherein the wearable glasses display a virtual object based on information on a game progress on the physical space received from the camera sensor.

3. The sports game simulation system of claim 1, wherein the real object is at least one of a ball, a stone, a racket, a bat, a stick, a broom, and gloves.

4. The sports game simulation system of claim 1, wherein the real object includes an inertial measurement unit sensor.

5. The sports game simulation system of claim 1, wherein the wearable glasses generate an entire game space so as to limit a space where a physical movement of the user is expected, of an entire game space where the sports are playing, within the actual physical space.

6. The sports game simulation system of claim 1, wherein the wearable glasses manage an entire game space so as to discontinuously change a space where a physical movement of the user is expected, of the entire game space where the sports are playing, within the actual physical space.

7. A sports game simulation method through wearable glasses which support an augmented reality mode, the method comprising:
receiving information on an actual physical space;
generating an entire game space based on the information on the actual physical space;
displaying a virtual object to be overlaid on the entire game space;
receiving information on a motion of a user; and
updating position information of the virtual object in the entire game space based on the information on the motion of the user.

8. The sports game simulation method of claim 7, wherein the entire game space is generated to be equal to or larger than the actual physical space.

9. The sports game simulation method of claim 7, wherein the entire game space is generated to be configured by an actual physical space and a pure virtual space.

10. The sports game simulation method of claim 7, wherein the entire game space is generated to be included in actual physical space by an external input.

11. The sports game simulation method of claim 7, wherein the entire game space is generated to be configured by a space expected that a physical movement of the user is generated and a space expected that the physical movement of the user is not generated.

12. The sports game simulation method of claim 7, wherein in the generating of an entire game space, the game space is adaptively configured by at least one of a role of the user in the game, a body condition of the user, and a choice of the user.

13. The sports game simulation method of claim 7, wherein an entire game space is managed so as to discontinuously change a space where a physical movement of the user is expected, of an entire game space where the sports are playing, within the actual physical space.
